(19) United States
(12) Patent Application Publication
(10) Pub. No.: US 2009/0303450 A1
(43) Pub. Date: Dec. 10, 2009

(54) Particle Detection on Patterning Devices with Arbitrary Patterns

(75) Inventor: Jason Douglas HINTERSTEINER, Norwalk, CT (US)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Holding N.V., Veldhoven (NL)

(21) Appl. No.: 12/471,023

(22) Filed: May 22, 2009

Related U.S. Application Data
(60) Provisional application No. 61/059,966, filed on Jun. 9, 2008.

(51) Int. Cl. G03B 27/52

(52) U.S. Cl. 355/30

(57) ABSTRACT

A detection system for detecting particle contamination in a lithographic apparatus includes an illumination system that directs a radiation beam onto a section of a surface of a patterning device to generate at least first and second components of patterned radiation. A first detector is configured to detect the first component. A filter is configured to adaptively change the second component based on the detected first component, and a second detector is configured to detect the filtered second component. An imaging device generates an image corresponding to the detected second filtered component, and the image indicates an approximate location of a particle on the surface of the patterning device.

This application claims the benefit of U.S. Provisional Appl. No. 61/059,966, filed Jun. 9, 2008, titled “Particle Detection on Patterning Devices with Arbitrary Patterns”, which is incorporated in its entirety herein by reference.

### BACKGROUND

1. Field of the Invention

The present invention relates to systems and methods for detecting particle contamination in a lithographic apparatus.

2. Related Art

A lithographic apparatus is a machine that applies a desired pattern onto a substrate or part of a substrate. A lithographic apparatus can be used, for example, in the manufacture of flat panel displays, integrated circuits (ICs) and other devices involving fine structures. In a conventional apparatus, light is directed to a patterning device, which can be referred to as a mask, a reticle, an array of individually programmable or controllable elements (maskless), or the like. The patterning device can be used to generate a circuit pattern corresponding to an individual layer of an IC, flat panel display, or other device. This pattern can be transferred onto all or part of the substrate (e.g., a glass plate, a wafer, etc.), by imaging onto a layer of radiation-sensitive material (e.g., resist) provided on the substrate. The imaging can include the processing of light through the like. Other components or devices can exist in a lithographic apparatus a projection system, which can include optical components such as mirrors, lenses, beam splitters, and that can also contain optical components, such as a multi-field relay (MFR), which contains optical components to divide a radiation beam into a number of individual beams prior to patterning.

Particle contamination is a common source of imaging defects in a lithographic apparatus. Further, patterning devices, such as reticles or masks, are especially susceptible to particle contamination. As such, many conventional lithographic apparatus cover the reticle or mask with a protective membrane, or pellicle, that is positioned such that contaminating particles that may interact with an illumination beam form parts of a patterned beam that are out of focus with respect to an image plane receiving the patterned illumination, and therefore the pellicle prevents these particles from causing errors in any image formed on the substrate. However, some extreme ultra-violet (EUV) lithography apparatus may include reflective reticles and masks not shielded from contaminating particles by a protective membrane or pellicle, thus rendering reticle inspection and cleaning essential to such EUV lithography processes.

Resolutions of existing reticle inspection technologies are often ill-suited to detect particle contamination in an EUV lithographic apparatus because they may be limited to being able to detect contamination of particles that are about 5 μm in size, or larger. However, due to the small feature sizes characteristic of EUV lithography, reticle inspection devices for use in EUV lithographic apparatus should be able to resolve particles about 10 nm to about 40 nm. As such, existing reticle inspection technologies generally lack the resolution to image particles in the size range most relevant to EUV lithography.

Further, existing reticle inspection technologies often incorporate one or more optical or other filters to correct characteristics of a patterned beam to compensate for particle contamination of the optics within the optical system. However, these filters are often not dynamic, and even if dynamic, existing filters typically require prior knowledge of the pattern information on the reticle or mask to allow for adjusting or setting of the filter. Unfortunately, due to the proprietary nature of the pattern information, most consumers of such technologies are extremely reluctant to provide the pattern information, thereby limiting the effectiveness of these existing, pattern-specific technologies.

### SUMMARY

Therefore, what is needed is a method and system for detecting particle contamination that can resolve particles in a size range relevant to EUV lithography, while also being able to dynamically adjust based on received arbitrary pattern data, thereby substantially obviating the drawbacks of the conventional systems.

In one embodiment, there is provided a system for detecting particle contamination of a patterning device in a lithographic apparatus. The system includes an illumination system configured to direct a radiation beam onto a section of a surface of the patterning device to generate at least first and second components of patterned radiation and first detector configured to detect the first component. A filter is configured to adaptively change the second component, the change being based on the detected first component, and a second detector is configured to detect the filtered second component. An imaging device is configured to generate an image corresponding to the detected second filtered component, and the image is configured to indicate an approximate location of a particle on the surface of the patterning device.

In a further embodiment, a lithographic apparatus includes a structure configured to receive a patterning device located in a vacuum environment, the patterning device being configured to pattern a beam of radiation, and a projection system configured to project the patterned beam onto a target portion of a substrate within the vacuum environment. The apparatus also includes a detection system that detects a respective particle contamination on a surface of the patterning device. The detection system includes an illumination system configured to direct a radiation beam onto a section of a surface of a patterning device to generate at least first and second components of patterned radiation and a first detector configured to detect the first component. A filter is configured to adaptively change the second component, the change being based on the detected first component, and a second detector is configured to detect the filtered second component. An imaging device is configured to generate an image corresponding to the detected second filtered component, and the image is configured to indicate an approximate location of a particle on the surface of the patterning device.

In a further embodiment, a method detects particle contamination within a lithographic apparatus. A section of a surface of a patterning device is illuminated with a beam of radiation to generate at least first and second components of patterned radiation. An intensity of the first component is measured, and the second component is filtered based on at least the measured intensity of the first component. An image corresponding to the filtered second component is generated based on at least the measured intensity of the second component, and any of the particle contamination on the illuminated section of the surface of the patterning device is identified based on an inspection of the generated image.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIGS. 1A and 1B schematically depict a lithographic apparatus, according to embodiments of the present invention.

FIG. 2 is a flowchart of an exemplary method for detecting particle contamination in a lithographic apparatus, according to an embodiment of the present invention.

FIG. 3 schematically depicts an exemplary system for detecting particle contamination in a lithographic apparatus, according to an embodiment of the present invention.

FIGS. 4A and 4B schematically depict exemplary systems for detecting particle contamination in a lithographic apparatus, according to embodiments of the present invention.

FIG. 5 illustrates features of the exemplary system schematically depicted in FIGS. 4A and 4B.

One or more embodiments of the present invention will now be described with reference to the accompanying drawings. In the drawings, like reference numbers can indicate identical or functionally similar elements.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

### Exemplary Lithographic Apparatus

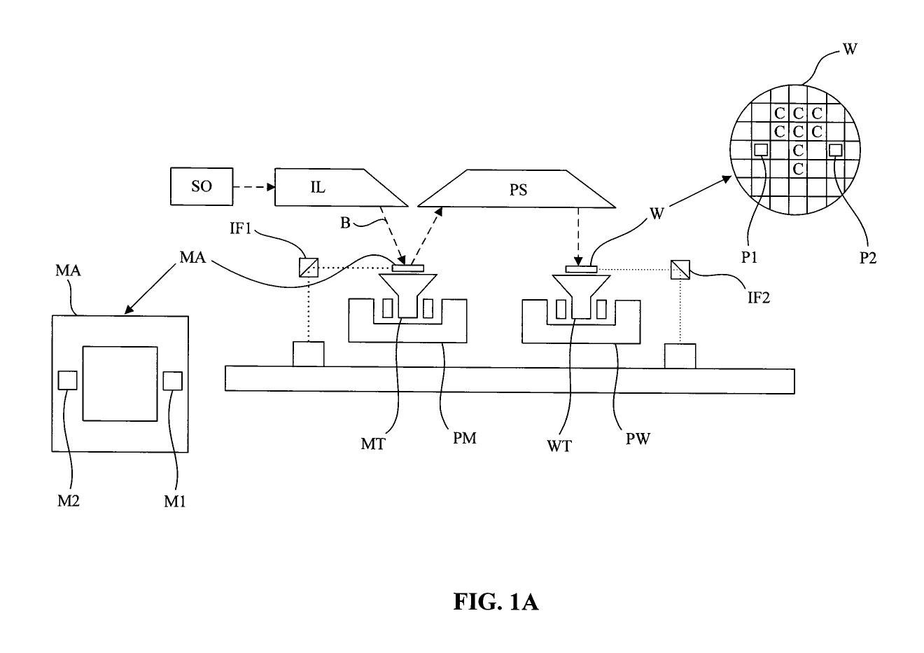

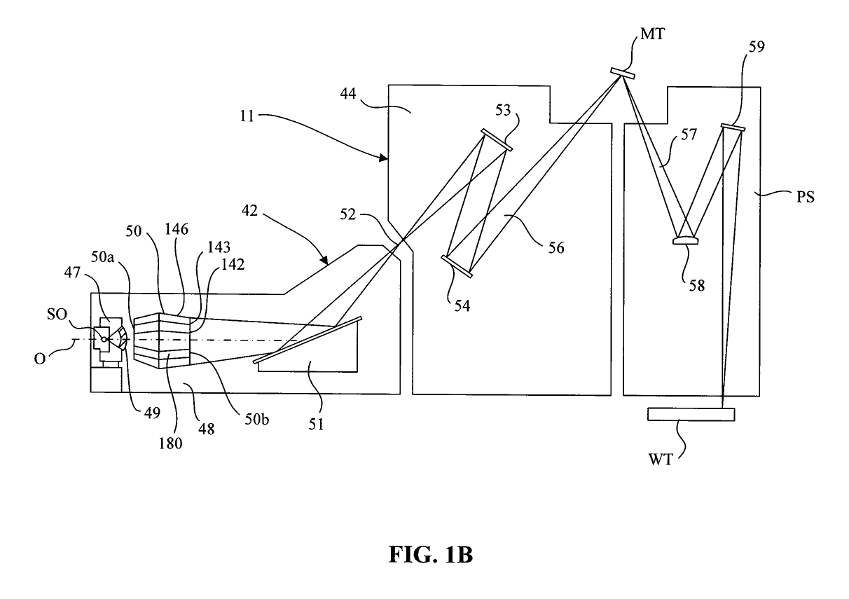

FIG. 1A schematically depicts a lithographic apparatus 1 according to one embodiment of the invention. The apparatus 1 includes an illumination system (illuminator) IL configured to condition a radiation beam B (e.g., UV radiation or EUV radiation). A support MT (e.g., a mask table) is configured to support a patterning device MA (e.g., a mask) and is connected to a first positioner PM that is configured to accurately position the patterning device in accordance with certain parameters. A substrate table WT (e.g., a wafer table) is configured to hold a substrate W (e.g., a resist-coated wafer) and is connected to a second positioner PW that is configured to accurately position the substrate in accordance with certain parameters. A projection system PS (e.g., a refractive projection lens system) is configured to project a pattern imparted to the radiation beam B by patterning device MA onto a target portion C (e.g., comprising one or more dies) of the substrate W.

The illumination system may comprise various types of optical components, including, but not limited to, refractive, reflective, magnetic, electromagnetic, electrostatic or other types of optical components, or any combination thereof, to direct, shape, or control radiation.

Support MT bears the weight of the patterning device. Further, support MT holds the patterning device in a manner that depends on the orientation of the patterning device, the design of the lithographic apparatus, and other conditions, such as, for example, whether or not the patterning device is held in a vacuum environment. Support MT can use mechanical, vacuum, electrostatic or other clamping techniques to hold the patterning device. Support MT can be a frame or a table, for example, which may be fixed or movable as required. Support MT may ensure that the patterning device is at a desired position, for example with respect to the projection system. Any use of the terms “reticle” or “mask” herein may be considered synonymous with the more general term “patterning device.”

The term “patterning device” used herein should be broadly interpreted as any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern comprises phase-shifting features or so-called assist features. Generally, the pattern imparted to the radiation beam will correspond to a particular functional layer in a device being created in the target portion, such as an integrated circuit.

The patterning device may be transmissive or reflective. Examples of patterning devices include, but are not limited to, masks, programmable mirror arrays, and programmable LCD panels. Masks are well known in lithography, and include binary, alternating phase-shift, and attenuated phase-shift masks, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including, but not limited to, refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As herein depicted, apparatus 1 is of a reflective type (e.g., employing a reflective mask). Alternatively, apparatus 1 may be of a transmissive type (e.g., employing a transmissive mask).

The lithographic apparatus may be of a type having two (dual stage) or more substrate tables (and/or two or more mask tables). In such “multiple stage” machines, the additional tables may be used in parallel, or preparatory steps may be carried out on one or more tables while one or more other tables are being used for exposure.

The lithographic apparatus may also be of a type wherein at least a portion of the substrate is covered by a liquid having a relatively high refractive index, e.g., water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1A, the illuminator IL receives radiation from a radiation source SO. The source and the lithographic apparatus may be separate entities, for example, when the source is an excimer laser. In such cases, the source is not considered to form part of the lithographic apparatus and the radiation is passed from the source SO to the illuminator IL with the aid of a beam delivery system that, for example, includes suitable directing mirrors and/or a beam expander. In additional embodiments, the source may be an integral part of the lithographic apparatus, for example when the source is a mercury lamp. The source SO and the illuminator IL, together with the beam delivery system BD, if present, may be referred to as a “radiation system.”

In an embodiment, the illuminator IL may comprise an adjuster configured to adjust the angular intensity distribution in a pupil plane of the radiation beam. Generally, at least the outer and/or inner radial extent (commonly referred to as σₒᵤₜₑᵣ and σᵢₙₙₑᵣ, respectively) of the intensity distribution in a pupil plane of the illuminator can be adjusted. In addition, the illuminator IL may include various other components, such as an integrator and a condenser. In such embodiments, the illuminator may be used to condition the radiation beam, to have a desired uniformity and intensity distribution in its cross-section.

The radiation beam B is incident on the patterning device (e.g., mask MA) that is held on the support (e.g., mask table MT) and is patterned by the patterning device. Having traversed the mask MA, the radiation beam B passes through the projection system PS, which focuses the beam onto a target portion C of the substrate W. With the aid of the second positioner PW and position sensor IF2 (e.g., an interferometric device, linear encoder or capacitive sensor), the substrate table WT can be moved accurately, e.g., so as to position different target portions C in the path of the radiation beam B. Similarly, the first positioner PM and another position sensor IF1 (e.g., an interferometric device, linear encoder or capacitive sensor) can be used to accurately position the mask MA with respect to the path of the radiation beam B, e.g., after mechanical retrieval from a mask library, or during a scan.

In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper, as opposed to a scanner, the mask table MT may be connected to a short-stroke actuator only, or may be fixed. Mask MA and substrate W may be aligned using mask alignment marks M1 and M2 and substrate alignment marks P1 and P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e., a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e., a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

In a further embodiment, lithographic apparatus 1 includes an extreme ultraviolet (EUV) source, which is configured to generate a beam of EUV radiation for EUV lithography. In general, the EUV source is configured in a radiation system (see below), and a corresponding illumination system is configured to condition the EUV radiation beam of the EUV source.

FIG. 1B schematically depicts an exemplary EUV lithographic apparatus according to an embodiment of the present invention. In FIG. 1B, a projection apparatus 1 includes a radiation system 42, an illumination optics unit 44, and a projection system PS. The radiation system 42 includes a radiation source SO, in which a beam of radiation may be formed by a discharge plasma. In an embodiment, EUV radiation may be produced by a gas or vapor, for example, from Xe gas, Li vapor, or Sn vapor, in which a very hot plasma is created to emit radiation in the EUV range of the electromagnetic spectrum. The very hot plasma can be created by generating at least partially ionized plasma by, for example, an electrical discharge. Partial pressures of, for example, 10 Pa of Xe, Li, Sn vapor or any other suitable gas or vapor may be required for efficient generation of the radiation. The radiation emitted by radiation source SO is passed from a source chamber 47 into a collector chamber 48 via a gas barrier or contaminant trap 49 positioned in or behind an opening in source chamber 47. In an embodiment, gas barrier 49 may include a channel structure.

Collector chamber 48 includes a radiation collector 50 (which may also be called collector mirror or collector) that may be formed from a grazing incidence collector. Radiation collector 50 has an upstream radiation collector side 50a and a downstream radiation collector side 50b, and radiation passed by collector 50 can be reflected off a grating spectral filter 51 to be focused at a virtual source point 52 at an aperture in the collector chamber 48. Radiation collectors 50 are known to skilled artisans.

From collector chamber 48, a beam of radiation 56 is reflected in illumination optics unit 44 via normal incidence reflectors 53 and 54 onto a reticle or mask (not shown) positioned on reticle or mask table MT. A patterned beam 57 is formed, which is imaged in projection system PS via reflective elements 58 and 59 onto a substrate (not shown) supported on wafer stage or substrate table WT. In various embodiments, illumination optics unit 44 and projection system PS may include more (or fewer) elements than depicted in FIG. 1B. For example, grating spectral filter 51 may optionally be present, depending upon the type of lithographic apparatus. Further, in an embodiment, illumination optics unit 44 and projection system PS may include more mirrors than those depicted in FIG. 1B. For example, projection system PS may incorporate one to four reflective elements in addition to reflective elements 58 and 59. In FIG. 1B, reference number 180 indicates a space between two reflectors, e.g., a space between reflectors 142 and 143.

In an embodiment, collector mirror 50 may also include a normal incidence collector in place of or in addition to a grazing incidence mirror. Further, collector mirror 50, although described in reference to a nested collector with reflectors 142, 143, and 146, is herein further used as example of a collector.

Further, instead of a grating 51, as schematically depicted in FIG. 1B, a transmissive optical filter may also be applied. Optical filters transmissive for EUV, as well as optical filters less transmissive for or even substantially absorbing UV radiation, are known to skilled artisans. Hence, the use of “grating spectral purity filter” is herein further indicated interchangeably as a “spectral purity filter,” which includes gratings or transmissive filters. Although not depicted in FIG. 1B, EUV transmissive optical filters may be included as additional optical elements, for example, configured upstream of collector mirror 50 or optical EUV transmissive filters in illumination unit 44 and/or projection system PS.

The terms “upstream” and “downstream,” with respect to optical elements, indicate positions of one or more optical elements “optically upstream” and “optically downstream,” respectively, of one or more additional optical elements. In FIG. 1B, the beam of radiation B passes through lithographic apparatus 1. Following the light path that beam of radiation B traverses through lithographic apparatus 1, a first optical elements closer to source SO than a second optical element is configured upstream of the second optical element; the second optical element is configured downstream of the first optical element. For example, collector mirror 50 is configured upstream of spectral filter 51, whereas optical element 53 is configured downstream of spectral filter 51.

All optical elements depicted in FIG. 1B (and additional optical elements not shown in the schematic drawing of this embodiment) may be vulnerable to deposition of contaminants produced by source SO, for example, Sn. Such may be the case for the radiation collector 50 and, if present, the spectral purity filter 51. Hence, a cleaning device may be employed to clean one or more of these optical elements, as well as a cleaning method may be applied to those optical elements, but also to normal incidence reflectors 53 and 54 and reflective elements 58 and 59 or other optical elements, for example additional mirrors, gratings, etc.

Radiation collector 50 can be a grazing incidence collector, and in such an embodiment, collector 50 is aligned along an optical axis O. The source SO, or an image thereof, may also be located along optical axis O. The radiation collector 50 may comprise reflectors 142, 143, and 146 (also known as a “shell” or a Wolter-type reflector including several Wolter-type reflectors). Reflectors 142, 143, and 146 may be nested and rotationally symmetric about optical axis O. In FIG. 1B, an inner reflector is indicated by reference number 142, an intermediate reflector is indicated by reference number 143, and an outer reflector is indicated by reference number 146. The radiation collector 50 encloses a certain volume, i.e., a volume within the outer reflector(s) 146. Usually, the volume within outer reflector(s) 146 is circumferentially closed, although small openings may be present.

Reflectors 142, 143, and 146 respectively may include surfaces of which at least portion represents a reflective layer or a number of reflective layers. Hence, reflectors 142, 143, and 146 (or additional reflectors in the embodiments of radiation collectors having more than three reflectors or shells) are at least partly designed for reflecting and collecting EUV radiation from source SO, and at least part of reflectors 142, 143, and 146 may not be designed to reflect and collect EUV radiation. For example, at least part of the back side of the reflectors may not be designed to reflect and collect EUV radiation. On the surface of these reflective layers, there may in addition be a cap layer for protection or as optical filter provided on at least part of the surface of the reflective layers.

The radiation collector 50 may be placed in the vicinity of the source SO or an image of the source SO. Each reflector 142, 143, and 146 may comprise at least two adjacent reflecting surfaces, the reflecting surfaces further from the source SO being placed at smaller angles to the optical axis O than the reflecting surface that is closer to the source SO. In this way, a grazing incidence collector 50 is configured to generate a beam of (E)UV radiation propagating along the optical axis O. At least two reflectors may be placed substantially coaxially and extend substantially rotationally symmetric about the optical axis O. It should be appreciated that radiation collector 50 may have further features on the external surface of outer reflector 146 or further features around outer reflector 146, for example a protective holder, a heater, etc.

In the embodiments described herein, the term “lens,” where the context allows, may refer to any one or combination of various types of optical components, comprising refractive, reflective, magnetic, electromagnetic and electrostatic optical components.

Further, the terms “radiation” and “beam” used herein encompass all types of electromagnetic radiation, comprising ultraviolet (UV) radiation (e.g., having a wavelength λ of 365, 248, 193, 157 or 126 nm) and extreme ultra-violet (EUV or soft X-ray) radiation (e.g., having a wavelength in the range of 5-20 nm, e.g., 13.5 nm), as well as particle beams, such as ion beams or electron beams. Generally, radiation having wavelengths between about 780-3000 nm (or larger) is considered IR radiation. UV refers to radiation with wavelengths of approximately 100-400 nm. Within lithography, it is usually also applied to the wavelengths, which can be produced by a mercury discharge lamp: G-line 436 nm; H-line 405 nm; and/or I-line 365 nm. Vacuum UV, or VUV (i.e., UV absorbed by air), refers to radiation having a wavelength of approximately 100-200 nm. Deep UV (DUV) generally refers to radiation having wavelengths ranging from 126 nm to 428 nm, and in an embodiment, an excimer laser can generate DUV radiation used within lithographic apparatus. It should be appreciated that radiation having a wavelength in the range of, for example, 5-20 nm relates to radiation with a certain wavelength band, of which at least part is in the range of 5-20 nm.

### Exemplary Systems and Methods for Detecting Particle Contamination in a Lithographic Apparatus

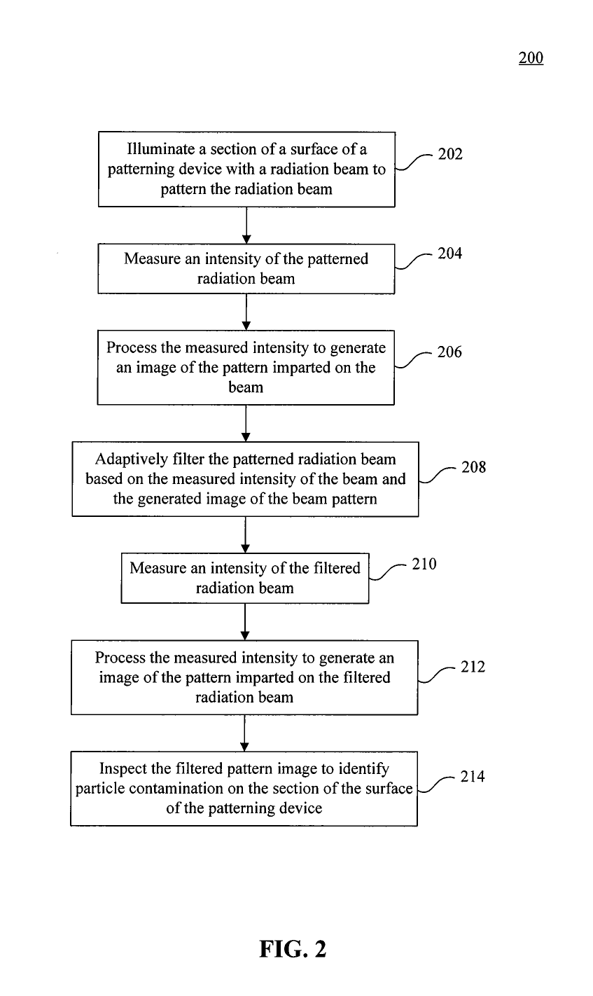

FIG. 2 depicts an exemplary method 200 for detecting particle contamination in a lithographic apparatus, according to one embodiment. In step 202, a section of a surface of a reflective patterning device, such as a mask or reticle, is illuminated by a beam of radiation. Upon falling incident on the section of the patterning device, the beam is scattered in a predictable and specific manner by the pattern present in the section of the patterning device, thereby imparting a pattern on a cross-section of the beam.

In an embodiment, step 202 illuminates the section of the reflective patterning device with a radiation beam having a wavelength substantially larger than a wavelength of radiation projected onto a substrate by the lithographic apparatus. Alternatively, step 202 illuminates the section of the reflective patterning device with a radiation beam having a wavelength that substantially equivalent to a wavelength of radiation projected onto a substrate by the lithographic apparatus. In an additional embodiment, the illuminating radiation beam may be of any wavelength without departing from the spirit or scope of the present invention.

The patterned radiation beam is reflected by the section of the patterning device, and an intensity (e.g., a cross sectional intensity) of the patterned radiation beam is then measured in step 204. The measured intensity is processed in step 206 to generate an image characteristic of the pattern (e.g., the distribution of intensity in a pupil plane associated with that pattern) imparted on the radiation beam by the section of the patterning device. In an embodiment, the surface of the patterning device is initially clean and free of particles, and as such, the image of the pattern generated in step 206 is representative of a portion of a pattern desired to be projected onto a substrate by the lithographic apparatus. In such an embodiment, step 206 can generate an image of the pattern present in the section of the patterning device without having prior knowledge of the geometry of the pattern, as is generally required in existing inspection technologies, as discussed above.

Based on the intensity measured in step 204 and the pattern image generated in step 206, the patterned radiation beam is adaptively or dynamically filtered to remove the generated pattern from the patterned radiation beam. In an embodiment, step 206 only configures a portion of an adaptive filter that spatially coincides with the illuminated section of the patterning device. In one embodiment, a filter (e.g., an LCD array) can filter a patterned radiation beam in response to the measured intensity and pattern image. In additional embodiments, two or more filters (e.g., substantially identical LCD arrays) can be aligned to filter the second component of the scattered radiation beam, alternatively the two or more substantially identical LCD arrays can be offset from each other, thereby forming a composite filter having a higher contrast ratio or a finer pixel grid than a comparable filter, e.g., a single LCD array.

Once adaptively filtered in step 208, an intensity (e.g., a cross-sectional intensity) of the filtered radiation beam is measured in step 210, and the measured intensity is processed in step 212 to generate, for example, a filtered image of the actual pattern present within the illuminated section of the patterning device. The filtered pattern image, generated in step 212, is then inspected in step 214 to detect for any particle contamination within the section of the patterning device illuminated in step 202.

In an embodiment, the adaptive filtering in step 208 filters out the intensity of the desired pattern from a clean and particle-free patterning device, as measured in step 204, from the patterned radiation beam. As such, if the illuminated section of the patterning device remains free of particulate contamination, the measured cross-sectional intensity of the filtered radiation beam will be substantially zero, and no pattern will be visible during the inspection of the filtered image in step 214.

However, in an embodiment where a contaminating particle is present within the illuminated section of the patterning device, the measured intensity of the filtered beam may be above zero in the vicinity of the contaminating particle due to the random scattering of the illuminating radiation beam by the contaminating particle. Therefore, the filtered image of the actual pattern would contain a sub-resolved image (e.g., a blob) indicative the contaminating particle, and an inspection of the filtered image in step 214 would identify not only the presence of the contaminating particle, but an approximate spatial location of the contaminating particle within the illuminated section of the patterning device.

In an embodiment, the steps of method 200 may be performed sequentially, with generation of the filtered image in step 212 occurring at a later time than the generation of the desired pattern image in step 206. However, in additional embodiments, the patterned radiation beam may be split using an optical element, such as a beam splitter or pick-off mirror, and the intensity measurement of the patterned beam and the generation of the pattern image in steps 204 and 206, respectively, may occur substantially simultaneously with the filtration of the patterned beam in step 208, the intensity measurement of the filtered beam in step 210, and the generation of the filtered image in step 212. Further in an additional embodiment, steps 202 through 212 may be repeated, either sequentially or simultaneously, for a different section of the surface of the patterning array.

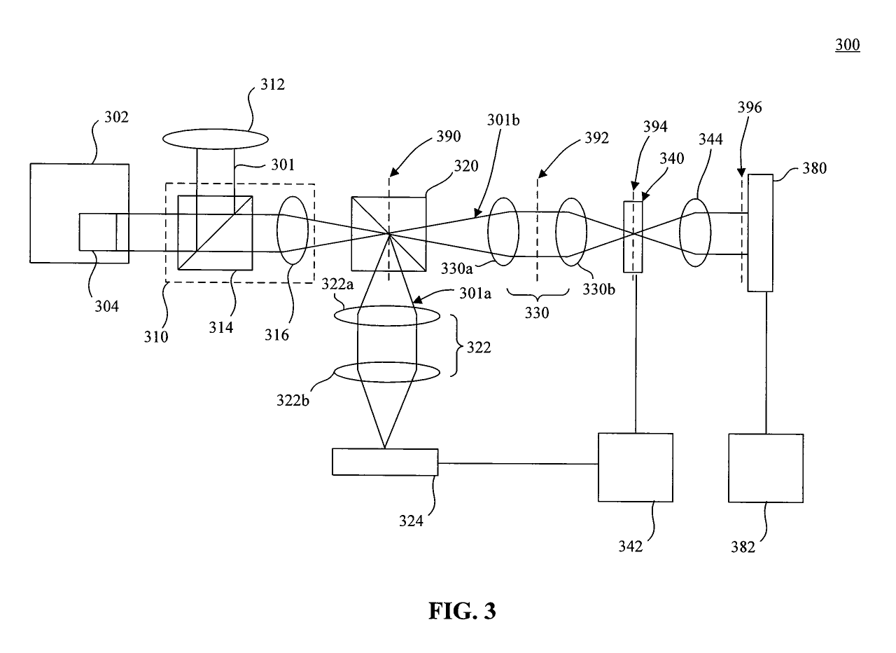

FIG. 3 depicts an exemplary system 300 for detecting particle contamination in a lithographic apparatus, according to one embodiment. System 300 includes an illumination system, shown generally at 310, that receives a beam of radiation 301 from a radiation source 312 and that conditions and transmits beam 301 towards a section 304 of a surface of a patterning device 302. In the embodiment of FIG. 3, a semi-transparent optical device 314 (e.g., a mirror, a beam splitter, or the like) within illumination system 310 directs beam 301 towards section 304.

Upon falling incident on section 304, beam 301 is scattered in a predictable and specific manner by the pattern present in section 304 of patterning device 302, thereby imparting a pattern on a cross-section of beam 301. Patterned radiation beam 301 is subsequently reflected from section 304 to illumination system 310, whereupon patterned beam 301 passes through semi-transparent mirror 314 and is focused by a condensing lens 316 onto a first pupil plane 390.

A beam splitter 320, positioned at or near first pupil plane 390, directs a first component 301a of patterned beam 301 toward an optical relay 322 that focuses first component 301a onto a first detector 324. In FIG. 3, optical relay 322 includes lenses 322a and 322b, although in alternative embodiments, optical relay 322 may include any other optical element or combinations of optical elements. In one embodiment, first detector 324 is a CCD camera, although in additional embodiments, first detector 324 may be any detector capable of measuring the intensity of first component 301a.

Further, beam splitter 320 can be simultaneously configured to transmit a second component 301b of patterned beam 301 to an optical relay 330 positioned about an intermediate field plane 392. Optical relay 330 focuses second component 301b onto a filter 340 (e.g., an adaptive LCD filter) positioned at or near a second pupil plane 394. In one example, adaptive LCD filter 340 may have a LCD array having a contrast ratio ranging from approximately 500:1 to 1000:1, or higher. Further, in the embodiment of FIG. 3, optical relay 330 includes lenses 330a and 330b positioned on opposite sides of intermediate field plane 390, although in alternative embodiments, optical relay 330 may include any other optical element or combinations of optical elements.

In FIG. 3, first detector 324 detects an intensity distribution of the unfiltered first component 301a, which may be transmitted through a wired or wireless network to be subsequently analyzed by a controller 342, which can be used to generate an image characteristic of the pattern imparted on radiation beam 301 by section 304 of patterning device 302. In an embodiment, the surface of patterning device 304 is initially clean and free of particles, and as such, the image of the pattern imparted onto first component 301b is representative of a portion of a pattern desired to be projected onto a substrate by the lithographic apparatus. In such an embodiment, controller 342, in conjunction with first detector 324, can generate an image of the pattern present in section 304 of the patterning device 302 without using any prior knowledge of the geometry of the pattern, as is generally required in existing inspection technologies.

In one example, the generated pattern image, and corresponding intensity measurements, can be subsequently transmitted from controller 342 to adaptive LCD filter 340, thereby allowing for setting of adaptive LCD filter 340 to filter the generated image pattern from the second component 301b. The adaptively filtered second component may then be focused by converging lens 344 onto a second detector 380 located at field 396, which is configured to detect an intensity of adaptively-filtered second component 301b. In an embodiment, second detector 380 may be a CCD camera, although in alternative embodiments, second detector 380 may be any detector capable to detecting the intensity of second component 301b.

In one example, the detected intensity is subsequently processed by second controller 382 to generate an image of the pattern present in the cross-section of adaptively-filtered second component 301b captured by second detector 380. The filtered image pattern, once generated by controller 382, may be inspected to detect the presence of any contaminating particles that may be on the surface of the patterning device 302.

For example, a pattern on the surface of the patterning device 302 scatters radiation from an incident radiation beam 301 in a specified and predictable manner. Therefore, by setting adaptive LCD filter 340 to filter out the desired pattern (e.g., that from a clean and particle-free patterning device) from the second component 301b, the measured intensity of second component 301b would be substantially zero if the patterning device 302 were to remain free of particulate contamination, and the resulting filtered image would contain no pattern.

However, contaminant particles on the surface of the patterning device 302 scatter an incident radiation beam 301 in a random manner. Therefore, upon filtering a desired pattern from the second component 301b, second detector 380 would measure residual intensity in the second component 301b due to the presence of contaminating particles on the surface of the patterning device 302. Once processed by second controller 382, the resulting filtered image would include a diffuse, sub-resolved region indicative of both the presence of a contaminant particle and its approximate spatial location within illuminated section 304 of patterning device 302.

In one example, adaptive filter 340 is a LCD array that can be set to filter, from second component 301b, the desired image pattern (e.g., that of a clean and particle-free patterning array) generated from measurements of the intensity of first component 301a. In an EUV lithography apparatus, a desired pattern may incorporate extremely small features that may range in size from about 10 nm to 40 nm, and as such, a suitable LCD filter 340 should incorporate a fine pixel array having a contrast ratio of greater than 10,000:1. However, existing LCD arrays often exhibit fairly coarse pixel arrays and may have contrast ratios ranging from 500:1 to 1,000:1. Therefore, for EUV applications, multiple LCD arrays may be coupled together to form composite filters that overcome the limitations of existing, single LCD arrays.

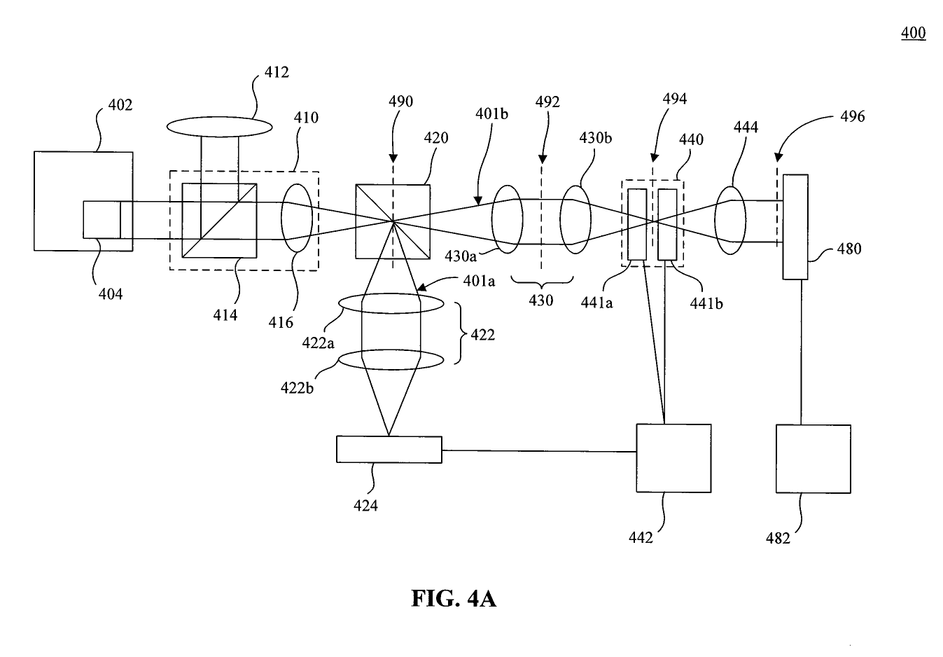

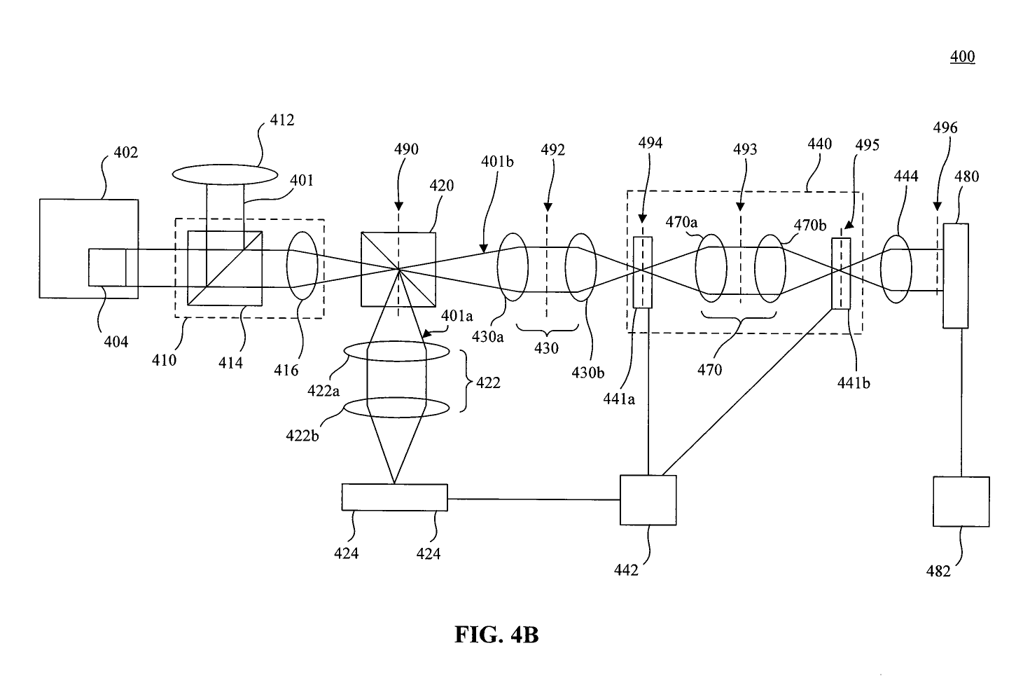

FIGS. 4A and 4B depict embodiments of an exemplary system 400 for detecting particle contamination in a lithographic apparatus that includes a composite filter, e.g., a LCD filter having multiple LCD arrays. In FIGS. 4A and 4B, similar elements are similarly identified, and a single description is provided for these similar elements in FIGS. 4A and 4B.

In FIGS. 4A and 4B, system 400 includes an illumination system, shown generally at 410, that receives a beam of radiation 401 from a radiation source 412 and that transmits beam 401 towards a section 404 of a surface a patterning device 402. Similar to as described above with reference to illumination system 310 shown in FIG. 3, illumination system 410 can include a semi-transparent optical device 414 (e.g., a mirror, a beam splitter, or the like) to direct beam 401 towards section 404.

Upon illumination with radiation beam 401, section 404 selectively scatters radiation beam 401, thereby imparting a pattern on a cross-section of radiation beam 401, and patterned radiation beam 401 is reflected by section 404 through semi-transparent optical device 414. A condensing lens 416 subsequently focuses patterned beam 401 onto a beam splitter 420 positioned at or near a first pupil plane 492.

Beam splitter 420 directs a first component 401a of patterned beam 401 toward an optical relay 422, which focuses first component 401a onto a first detector 424. In FIGS. 4A and 4B, optical relay 422 includes lenses 422a and 422b, although in alternate embodiments, optical relay 422 may include any additional optical element or combinations of optical elements that would be apparent to one skilled in the art. In one embodiment, first detector 424 is a charge-coupled device (CCD) camera, although in additional embodiments, first detector 424 may be any detector capable of measuring the intensity of first component 401a.

In FIGS. 4A and 4B, first detector 424 detects an intensity of the unfiltered first component 401a, which may be transmitted through a wired or wireless network to be subsequently analyzed by controller 424, which can be used to generate an image characteristic of the pattern imparted on radiation beam 401 by section 404 of patterning device 402. In an embodiment, the surface of patterning device 404 is initially clean and free of particles, and as such, the image of the pattern imparted onto first component 401b can represent an image of a pattern desired to be projected onto a substrate by the lithographic apparatus. In such an embodiment, controller 424, in conjunction with first detector 424, can generate an image of the pattern present in section 404 of patterning device 402 without using any prior knowledge of the geometry of the pattern, as is generally required in existing inspection technologies.

Further, beam splitter 420 can be simultaneously configured to transmit a second component 401b of patterned beam 401 to an optical relay 430 positioned about an intermediate field plane 492. In FIGS. 4A and 4B, optical relay 430 includes lenses 430a and 430b positioned on opposite sides of intermediate field plane 492, although in alternate embodiments, optical relay 430 may include any other optical element or combinations of optical elements.

Optical relay 430 then focuses second component 401b onto a composite LCD filter 440. In contrast to the adaptive LCD filter depicted in FIG. 3, composite LCD filter 440 includes two, or more, LCD filters configured to collectively filter second component 401b in response to a pattern image generated by controller 424.

In FIG. 4A, composite LCD filter 440 includes a first LCD filter 441a and a identical second LCD filter 441b positioned about a second pupil plane 494 such that first LCD filter 441a is disposed optically upstream of second LCD filter 441b. In contrast, composite LCD filter 440 of FIG. 4B includes a first LCD filter 441a positioned at a second pupil plane 494 and an identical second LCD filter 441b positioned at a third pupil plane 495. In FIG. 4B, an optical relay 470 is positioned at a second intermediate field 493, which is located between first LCD filter 441a and second LCD filter 441a. Optical relay 470 includes lenses 470a and 470b positioned about second intermediate field plane 493, although in alternate embodiments, optical relay 470 may include any additional optical element or combinations of optical elements.

In both FIGS. 4A and 4B, controller 424 transmits the pattern image and the corresponding intensity measurements of the first component 401a to first LCD array 441a and to second LCD array 441b, thereby allowing for setting of first LCD filter 441a and second LCD filter 441b to collectively and individually filter the pattern of first component 401a from the second component 401b. Second component 401b is then initially filtered by first LCD filter 441a. Initially-filtered second component 401b then falls directly incident onto second LCD filter 441b, as depicted in FIG. 4A, or alternatively, initially-filtered second component 401b is focused by optical relay 470 onto second LCD filter 441b, as depicted in FIG. 4B. Second LCD filter 441b subsequently filters initially-filtered second-component 401b, thereby eliminating the pattern of first component 401a from second component 401b.

In one example, LCD filters 441a and 441b of FIGS. 4A and 4B can be substantially identical LCD arrays exhibiting a substantially identical pixel grid and having substantially identical contrast ratios ranging from about 500:1 to about 1000:1, or higher. Further, in one embodiment, identical LCD arrays 441a and 441b of FIGS. 4A and 4B can be positioned, such that each pixel of first LCD filter 441a is aligned with a corresponding pixel of second LCD filter 441b. As such, composite LCD filter 440, which includes aligned LCD filters 441a and 441b, has a substantially higher contrast ratio than adaptive LCD filter 340 of FIG. 3. For example, if LCD arrays 441a and 441b respectively have contrast ratios of about 500:1, an effective contrast ratio for composite filter 440 would be about 500²:1, or about 250,000:1.

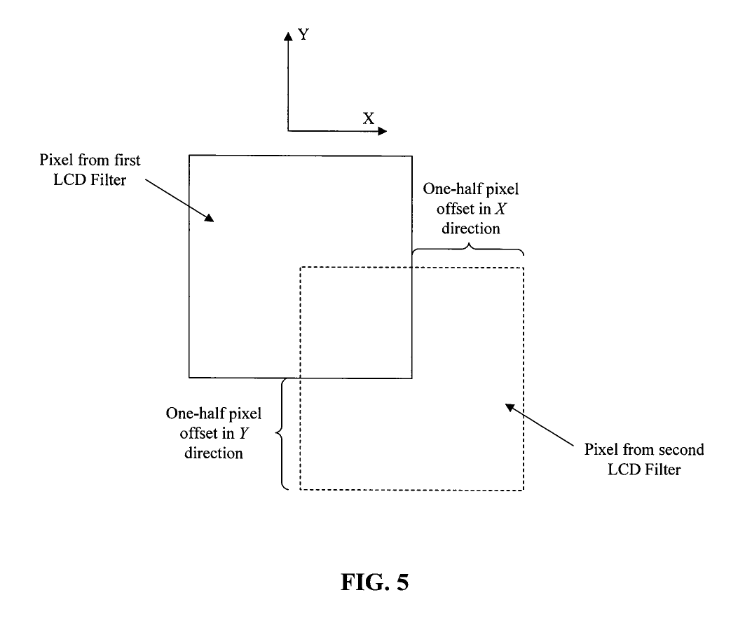

Additionally, or alternatively, LCD filters 441a and 441b of FIGS. 4A and 4B can be positioned, such that LCD filter 441a is slightly offset from LCD filter 441b, thereby substantially increasing the fineness of the effective pixel grid of composite filter 440. For example, and as depicted in FIG. 5, for exemplary pixels of LCD filters 441a and 441b, each pixel of first LCD filter 441a may be offset from a corresponding pixel of second LCD filter 441b by one-half pixel in a X-direction and one-half pixel in a Y-direction. In such an embodiment, composite LCD filter 440 can have a substantially finer effective pixel grid than adaptive LCD filter 340 of FIG. 3.

In FIGS. 4A and 4B, adaptively-filtered second component 401b is subsequently focused by condensing lens 444 onto a second detector 480 located at field 496, which is configured to detect an intensity of adaptively-filtered second component 401b. In an embodiment, second detector 480 may be a CCD camera, although in alternative embodiments, second detector 480 may be any detector capable to detecting the intensity of second component 401b.

In one example, the detected intensity is subsequently processed by a second controller 482 to generate an image of the pattern present in the cross-section of adaptively-filtered second component 401b captured by second detector 380. The filtered image pattern, once generated by controller 482, may be inspected to detect the presence of any contaminating particles that may be on the surface of the patterning device 402.

For example, a pattern on the surface of the patterning device 402 scatters radiation from an incident radiation beam 401 in a specified and predictable manner. Therefore, by setting composite LCD filter 440, and thus, first LCD filter 441a and second LCD filter 441b, to filter out the desired pattern (e.g., that from a clean and particle-free patterning device) from the second component 401b, the measured intensity of second component 401b would be substantially zero if the patterning device 402 were to remain free of particulate contamination, and the resulting filtered image would contain no pattern.

However, contaminant particles on the surface of the patterning device 402 scatter an incident radiation beam 401 in a random manner. Therefore, upon filtering a desired pattern from the second component 401b, second detector 480 would measure residual intensity in the second component 401b due to the presence of contaminating particles on the surface of the patterning device 402. Once processed by second controller 482, the resulting filtered image would include a diffuse, sub-resolved region indicative of both the presence of a contaminant particle and its approximate spatial location within illuminated section 404 of patterning device 402.

In one example, the exemplary systems of FIGS. 3, 4A, and 4B may be incorporated into an EUV lithographic apparatus, such as the apparatus depicted in FIGS. 1A and 1B, to detect and monitor particulate contamination on the surface of an initially-clean and particle-free EUV reticle. In such an embodiment, a wavelength of the radiation beam, such as beam 301 of FIG. 3 and/or beam 401 of FIGS. 4A and 4B, may set to about 400 nm, a value substantially larger than the wavelength of the EUV radiation that exposes the substrate.

However, the present invention is not limited to radiation beam of about 400 nm. In additional embodiments, the exemplary systems of FIGS. 3, 4A, and 4B may illuminate the section of the patterning using a radiation beam having any of a number of wavelength values. Additionally, or alternatively, the exemplary systems of FIGS. 3, 4A, and 4B may illuminate the section of the patterning array with a beam of EUV radiation generated by an EUV radiation source within an EUV lithographic apparatus, such as those described in FIGS. 1A and 1B.

In an additional embodiment, the exemplary systems of FIGS. 3, 4A, and 4B may be incorporated into a stand-alone inspection device. In such an embodiment, the exemplary systems may be used to inspect a reflective patterning device, such as a reticle or mask, prior to installation or at any other point within the lithographic process.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

What is claimed is:

1. A system for detecting particle contamination of a patterning device in a lithographic apparatus, comprising:
an illumination system configured to direct a radiation beam onto a section of a surface of the patterning device to generate at least first and second components of patterned radiation;
a first detector configured to detect the first component;
a filter configured to adaptively change the second component, the change being based on the detected first component;
a second detector configured to detect the filtered second component; and
an imaging device configured to generate an image corresponding to the detected second filtered component,
wherein the image is configured to indicate an approximate location of particle contamination on the surface of the patterning device.

2. The system of claim 1, wherein the filter comprises a liquid crystal device (LCD) array.

3. The system of claim 1, wherein the filter comprises a first LCD array of pixels and a second LCD array of pixels.

4. The system of claim 3, wherein each pixel of the first LCD array is aligned with a corresponding pixel of the second LCD array.

5. The system of claim 3, wherein each pixel of the first LCD array is offset from a corresponding pixel of the second LCD array.

6. The system of claim 3, further comprising:
an imaging device configured to generate an image corresponding to the detected first component,
wherein the filter is configured to adaptively filter the second component based on the generated image.

7. The system of claim 6, wherein the generated image corresponds to an image of a pattern imparted onto the first component by the section of the patterning device.

8. The system of claim 7, wherein the section of the patterning device is free of particles.

9. A lithographic apparatus, comprising:
a structure configured to receive a patterning device located in a vacuum environment, the patterning device being configured to pattern a beam of radiation;
a projection system configured to project the patterned beam onto a target portion of a substrate within the vacuum environment; and
a detection system configured to detect a respective particle contamination on a surface of the patterning device, comprising:
an illumination system configured to direct a radiation beam onto a section of a surface of a patterning device to generate at least first and second components of patterned radiation;
a first detector configured to detect the first component;
a filter configured to adaptively change the second component, the change being based on the detected first component;
a second detector configured to detect the filtered second component; and
an imaging device configured to generate an image corresponding to the detected second filtered component,
wherein the image is configured to indicate an approximate location of particle contamination on the surface of the patterning device.

10. The lithographic apparatus of claim 9, wherein the filter comprises a liquid crystal device (LCD) array.

11. The lithographic apparatus of claim 9, wherein the filter comprises a first LCD array of pixels and a second LCD array of pixels.

12. The lithographic apparatus of claim 9, wherein each pixel of the first LCD array is aligned with a corresponding pixel of the second LCD array.

13. The lithographic apparatus of claim 11, wherein each pixel of the first LCD array is offset from a corresponding pixel of the second LCD array.

14. The lithographic apparatus of claim 11, further comprising:
an imaging device configured to generate an image corresponding to the detected first component,
wherein the filter is configured to adaptively filter the second component based on the generated image.

15. The lithographic apparatus of claim 14, wherein the generated image corresponds to an image of a pattern imparted onto the first component by the section of the patterning device.

16. The lithographic apparatus of claim 15, wherein the section of the patterning device is free of particles.

17. A method for detecting particle contamination on a patterning device in a lithographic apparatus, comprising:
(a) illuminating a section of a surface of a patterning device with a beam of radiation to generate at least first and second components of patterned radiation;
(b) measuring an intensity of the first component;
(c) filtering the second component based on at least the measured intensity of the first component;
(d) generating an image corresponding to the filtered second component based on at least the measured intensity of the second component; and
(e) identifying particle contamination on the illuminated section of the surface of the patterning device based on an inspection of the generated image.

18. The method of claim 17, wherein step (d) comprises:
measuring an intensity of the filtered second component.

19. The method of claim 17, wherein step (b) comprises:
generating an image of a pattern imparted onto the first component by the section of the surface of the patterning device based on the measured intensity of the first component.

20. The method of claim 17, wherein step (a) comprises:
illuminating a section of a surface of a particulate-free patterning device with a beam of radiation to generate patterned radiation.

21. The method of claim 17, wherein step (c) comprises:
filtering out the measured intensity of the first component from the second component to generate a filtered radiation beam.

22. The method of claim 21, wherein step (e) comprises:
identifying one or more sub-resolved images in the generated pattern to detect if there is any of the particle contamination.

23. The method of claim 21, wherein step (e) further comprises:
identifying a location of any respective particle within the section of the surface of the patterning device based on a location of a sub-resolved image in the generated pattern.

24. The method of claim 17, further comprising:
(f) repeating steps (a) through (e) for a different section of the surface of the patterning device.
